(19) United States
(12) Patent Application Publication
(10) Pub. No.: US 2020/0309084 A1
(43) Pub. Date: Oct. 1, 2020

(54) EXTRACTING KINETIC ENERGY FROM THE CAPILLARITY OF FLUID AND METHOD OF DOING THE SAME.

(71) Applicant: Joseph Paul Bakhos, Anaheim, CA (US)

(72) Inventor: Joseph Paul Bakhos, Anaheim, CA (US)

(21) Appl. No.: 16/367,337

(22) Filed: Mar. 28, 2019

(51) Int. Cl. F03B 13/00; H02K 7/18; F03G 3/06

(52) U.S. Cl. CPC F03B 13/00; F03G 3/06; H02K 7/1853

(57) ABSTRACT

Disclosed is a device which incorporates a process by which an absorptive material is used to absorb fluid, the weight of said fluid causes the device to move without any outside energy source. The fluid, by way of evaporation or by being absorbed into another absorptive material, substantially disappears, causing the device to return back to its starting position on its own, and repeat the process. The fluid, which is stocked in a holding area, remains stagnant, until the device in its starting position is made in contact with the fluid by use of a counterweight, and thereby absorbs the fluid, however, when the device is saturated, the greater volume of absorbent on one side causes the device to move to its activated position. In its activated position, the device is not exposed to the fluid and therefore remains until the fluid is evaporated or absorbed into another absorbent. In doing so, the device has converted the potential energy in an unsaturated absorbent into kinetic energy. This kinetic energy can be used to, for example rotate an axis that is connected to a magnet within a fixed copper coil, or vice a versa, thereby converting this newly created kinetic energy into electricity.

### BRIEF DESCRIPTION OF THE DRAWINGS

FIG. 1 consists of a lineal absorbent in which the axis point is situated more than 50% distance from the mouth and less than 50% distance from the tail end. When the absorbent mouth, is exposed to the liquid, it is substantially unsaturated and the counterweight causes the device to turn the absorbent toward the liquid (usually water). When in contact with the water, the water travels on its own volition up the mouth, past the axle point, and causes the absorbent to be saturated which in turn causes the device to be heavier on the tail side of the axle which is more voluminous in absorbent material thereby causing the device to turn.

FIG. 2 is a side profile in which the circular figure is the axle and the linear shape is the absorbent. The smaller darker linear figure is the counterweight.

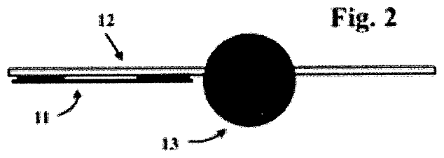

FIG. 3 consists of the device as depicted in FIG. 1 however the device is in its activated position.

FIG. 4 Shows the direction and movement of the device depicted in FIGS. 1, 2, & 3.

### DESCRIPTION

It is the capillary motion of liquid through the tiny holes in the absorptive that causes the fluid to be sucked up, whereby gravity seeks to pull the heavier material downward. The purpose of the machine is to harness the potential energy of an unsaturated absorbent by exposing it to a fluid, then converting the potential energy into kinetic energy while simultaneously separating the absorptive from the fluid source. The devices' axis may, for example, be connected to a magnet within a fixed copper coil, or a copper coil surrounding or surrounded by a magnet, thereby converting the newly created kinetic energy into electricity, it may also be connected to another gear or any object for the purpose of moving that object.

This is not a patent for the natural occurrence of capillarity and evaporation, this is a utility patent for any method of converting the potential energy in the said phenomena into kinetic energy. One embodiment of this function would be to connect the moving absorptive to any other object or axis causing the said object to move as well. This movement would be without any outside energy source. The premise of the device is to use the capillary motion of fluid as energy, whereby the fluid is the fuel. When the fluid disappears through the evaporation into the atmosphere around it, for example, the fluid has burned similar to that of gasoline in an engine. The faster the fluid is either evaporated or extracted the faster the machine will move. The removal of the fluid can be by either the evaporation or extraction.

### Evaporation:

When the absorbent is made heavier by its absorbing of the fluid, the fluid will remain indefinitely pending its own natural evaporation which is based on the atmospheric properties surrounding the absorptive. These properties include but are not limited to the atmospheric humidity and temperature. In a dry environment, the absorptive will seek to equalize with its surroundings causing the fluid to evaporate faster than in a very humid environment. Creating the ideal environment may be needed to allow the device to function properly.

### Extraction Method:

The extraction method uses more controlled techniques to extract the saturated water from the absorbent. Causing the activated (saturated) absorptive device to become in contact with an unsaturated absorptive device, the two absorptive's seek to gain equilibrium. Thereby transferring fluid from one absorptive to the other.

### Leverage:

One such embodiment of this design would be to move the machine by use of leverage. Whereby the axle is situated in a see-saw like fashion. The “mouth” of the device when in its starting position is in contact with the fluid or another saturated absorptive material. The leverage of the design is that when the absorptive gains weight as it absorbs the fluid, the weight at the end of the see-saw causes the see-saw to activate and fall toward the heavier side. In doing so, the mouth is also lifted, thereby depriving the mouth of the device from the fluid. At this point, the fluid can either remain indefinitely until it evaporates naturally or be absorbed into another unsaturated absorptive.

### The Absorbent:

The easiest example of a usable absorbent for purposes of this device is a household dish sponge. Nonetheless, numerous materials can be used for this purpose. Everything from synthetic and non-synthetic materials such as fabric or plastics, glass, or possibly organic materials such as wood, sand, soil, cotton or paper may be used as an absorbent. Capillary tubes or compressed glass or plastic sheets may also be used. This list is not exhaustive. Any material capable of absorbing a fluid would work. For this discussion we will consider a household dish sponge. These sponges have tiny holes, that use the laws of nature to inherit fluid by capillary motion. This absorptive nature seems at times to “defy the laws of gravity”, this defiance is what this device seeks to harness as kinetic energy. The lifting of the fluid is the “work” that we seek to harness. Hypothetically, submerging half of the sponge into water, will cause the reminder of the sponge to become saturated, without further action from the user. This capillary motion through the sponge is the energy in which this device seeks to harness. Some sponges are more efficient and effective than others. The smaller the gaps between the holes, the more effective the sponge will be. For purposes of the experimentation that is depicted in this patent we are using what is known as a PVA sponge.

### Other Capillary Devices:

For purposes of this patent, other capillary devices refers to existing devises that exhibit the properties of an absorbent by using capillary action. These devises include capillary tubes of any material (metal, glass, plastic, etc.). Other Capillary devices also include crude devices such as putting two materials together to create narrow spaces that absorb fluid. For example, two pieces of glass against each other will “absorb” fluid if exposed to the fluid. These two pieces of glass would be classified as other “capillary devices” for purposes of this patent. Any device with narrow enough spaces to absorb any fluid would be sufficient to create the utility that is claimed and described in this patent.

### The PVA Sponge:

The PVA sponge is a synthetic sponge essentially composed of Polyvinyl Alcohol. It is an open-celled, highly absorbent porous material that wicks aqueous solutions quickly. It is compressible when dry, expandable when wet, has high tensile strength, good elongation and excellent resistance to most chemicals.

PVA sponge is hydrophilic and can hold up to 12 times its dry weight in water. This weight is water or other liquid is what causes the device to move. The more weight the sponge is capable of taking on, the easier it will be for the device to move. Cell size can be varied depending on the required use; the finer the cell the better the capillary action. The wet sponge can withstand temperatures approaching 70° C. and the dry about 100° C. The PVA sponge is effectively inert and will not, in itself, support microbial growth. Wet packed sponge can be treated chemically to inhibit mould and bacterial growth.

### BACKGROUND OF THE INVENTION

It would be very useful to gather energy, in the form of kinetic energy, from the capillary motion of fluid or, furthermore, from the natural evaporation of certain fluids or chemicals. It would be useful for a variety of reasons, for example, to convert this kinetic energy into electricity. When placing an unsaturated sponge into a cup of water for instance, one can see that the water level goes down while the sponge becomes more saturated. The water travels up, against gravity, into the tiny crevices of the sponge. This process exhibits a very clear amount of potential energy. However, there is no device that harnesses that energy in the form of kinetic energy. In essence, it would be convenient to get kinetic energy motion by just “adding water”.

For example, water flows from the soil up through the branches of a tree, and the atmosphere around the tree dry it up. This is energy that has surrounded humans since the beginning of time. While we have many methods of gaining energy, and many political and economic forces to affect these ends, the need for new clean energy has never been more apparent than present day. As the water evaporates and forms clouds, when the clouds get heavy, they rain down the water that was absorbed, and the process is thereby repeated. Similar to my invention, the weight of the absorbed fluid will cause the device to move downward with the force of gravity, the difference being, when this downward force takes effect, the absorptive is to be separated from the fluid source. Theoretically, there is energy in the constant evaporation of water into the earths atmosphere, however this energy is not being harnessed for human needs. This device seeks to change this notion. This device seeks to harness the constant evaporation and capillary motion of fluid for human benefit.

For example, if the weight of the fluid in the saturated absorptive was on a balance, it could lift an object of the equivalent weight, then, when the water is removed, either by evaporation or extraction, the device could return to its original state and repeat the process.

For purposes of experimentation for this specific device, the PVA Sponge will be used. A standard PVA sponge with the dimensions of 7.3×16.5×3.2 cm has a weight of 227 grams. When fully saturated, the same PVA sponge that weighs 227 grams when dry weighs 2270 grams. It is important to note that the general ratio of weight between the dry and wet sponge is irrelevant to the working nature of the machine. It is the surface area and the added weight of the fluid that causes the machine to move.

The machine typically works on two natural phenomena. Capillarity and evaporation. Note that this is not a patent for the natural occurrence of these phenomena, this is a utility patent for any method of converting the potential energy in these phenomena into kinetic energy. The noun capillarity is described as the tendency of a liquid in a capillary tube or absorbent material to rise or fall as a result of surface tension. The noun evaporation is described as the process of turning from liquid into vapor. These two phenomena occur in the natural world constantly, however, they are rarely if ever used for energy producing purposes.

### Volume of the Absorbent:

In using the evaporation method to repeat the processes described in the preceding pages, the thinner the absorbent, the quicker it would become unsaturated by its natural evaporation. If, for example, there was an extremely thin layer of absorbent which was affixed to its own frame, the movement of the device, de-exposing the mouth from the liquid, the thin layer of the absorbent would dry and become unsaturated much faster than a thick absorbent.

It is extremely important to note, that, as depicted in the embodiments of the device, the volume of the absorbent is greater past the axle point. The counterweight (as described in more detail later) is what causes the device to fall toward the fluid when the absorbent is unsaturated, however, the saturated absorbent, which is more voluminous on one side of the axle point, is heavier than the counterweight and the rest of the absorbent on the mouth side of the device. Therefore, when the absorbent is saturated, it causes the device to turn.

### The Counterweight:

The counterweight is composed of a non-absorbent material, so as to not interfere with the processes and to remain consistent in its weight. The purpose of the counterweight is to shift the absorbent toward the fluid when the absorbent is unsaturated. However, when the absorbent is saturated, the weight of the absorbent exceeds that of the counterweight, therefore causing the device to move. In this movement, the absorbent is simultaneously separated from the fluid, thereby allowing either the liquid to dry or be extracted, and allowing the device to return to its original position.

The location of the counterweight is irrelevant, so long as the counterweight performs its function as to cause the devices “mouth” to make contact with the fluid when the absorbent is unsaturated. The counterweight may be affixed to the absorbent itself, or located, for example on any other part of the axle which the absorbent is affixed. The key is that the volume of the absorbent is greater on the opposite side of the counterweight, in other words, the volume of the absorbent is greater on the opposite side of the “mouth”. Thereby, when saturated, causing its own weight to exceed the weight of the counterweight and causing the device to move.

### Surface Tension:

Surface tension is the tension of the surface film of a liquid caused by the attraction of the particles in the surface layer by the bulk of the liquid, which tends to minimize surface area. The surface tension of the liquid will cause the device to absorb the liquid but simultaneously hold the device from turning because the device is submerged just below the surface of the liquid. It is important that the weight of the “tail” end, described is more detail below, exceeds the hold of the surface tension, thereby allowing the device to break hold from the liquid and turn on its own weight.

### BEST MODE FOR CARRYING OUT THE INVENTION

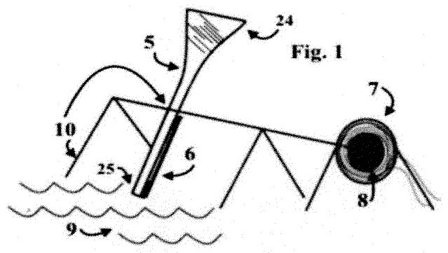

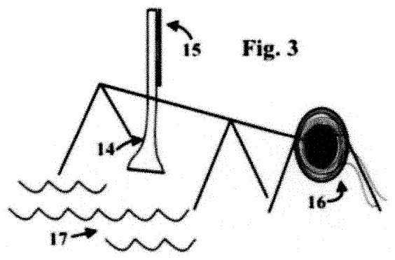

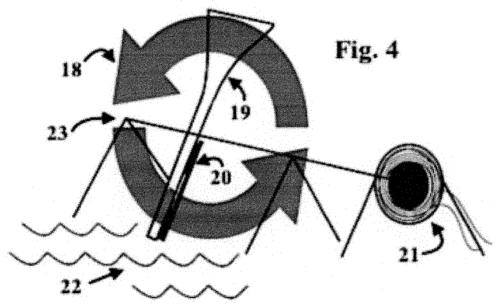

The best mode for carrying out this invention is depicted in the attached images. As shown in FIG. 1, it consists of a lineal absorbent 5 in which the axis point 10 is situated more than 50% distance from the mouth and less than 50% distance from the tail end. The “mouth” FIG. 25, and the “tail”, FIG. 24. When the absorbent mouth, FIG. 25, is exposed to the liquid, FIG. 9, 17, 22, it is substantially unsaturated and the counterweight 6 causes the device to turn the absorbent toward the liquid (usually water) FIG. 9. When in contact with the water FIG. 9, the the water travels on its own volition up the mouth, past the axle point, and causes the absorbent to be saturated which in turn causes the device to be heavier on the tail side of the axle which is more voluminous in absorbent material (FIG. 24) thereby causing the device to turn in the direction depicted by FIG. 4, 18. The liquid as shown in FIGS. 9, 17, 22, can be water or any other fluid. Note that the liquid is situated at the bottom of the device because the essence of the device is that the absorbent does the work, i.e. lifting the fluid past the axis point to cause the device to move. As shown in 7, 8, 16, 21, the kinetic motion of the device is converted into electricity in this instance, and as shown in 7, 8, 16, 21, the fixed copper coil is situated around the rotating magnet, thereby creating electricity. The absorbent in 5, 12, 14, and 19, starts thin at its mouth when it comes in contact with the fluid, however is much thicker when it reaches past the axle point. This goes to the essence of the device, when the unsaturated device is at rest and substantially unsaturated, the counterweight causes the mouth to flow downward. However, when the device is saturated, the thicker absorbent takes on the weight of the fluid and causes the device to turn. Note: the weight of the counterweight is more than the that of the unsaturated portion of the device past the axle point, however it is lighter that the saturated portion of the absorbent past the axle point. Finally, the reason why the “mouth” FIG. 25, extends past the axle farther than than the “tail”, FIG. 24, is because when the device turns and is saturated it is simultaneously separated from the liquid and does not make contact with the liquid otherwise when in its “activated position” FIG. 3, as shown FIG. 14, the absorbent is not made in contact with the liquid when activated.

### Embodiment 1

In the preferred embodiment of this device, the axis has two sides, similar to an equation. The side that the “mouth” or narrow end of the absorbent shown in FIGS. 5, 12, 14, and 19, is longer than the “tail” end of the absorbent shown in the same. In other words, the side of the axis that makes contact with the liquid is longer. this is because when the device is activated, FIG. 3, through the motion shown in FIG. 4, it is important that no other part of the absorbent makes contact with the liquid. When no other potion makes contact with the liquid, then the fluid can evaporate or be extracted, and the device return to its starting position without any additional labor of the user. In this embodiment, when the sponge becomes saturated, its weight on the “tail” end FIG. 24 is greater than the weight of the mouth and the counterweight combined FIGS. 6 & 25. When the device is activated, the tail falls with gravity, however, the tail does not make contact with the liquid because it is shorter than the mouth. The formula for calculating the correct volume of absorbent concerning the mouth or tail end is dependent on the absorptive capacity of the absorptive (sponge) (FIGS. 5, 12, 14, 19). The more fluid the absorptive can hold the more weight it will take on by its capillarity. There is no fixed measurements, it can be microscopic or fairly large.

For example: lets say the absorptive takes on 10 times its weight in water. Lets assume the total weight of the unsaturated absorbent FIG. 5, is 11 grams. The mouth FIG. 25, and the tail, FIG. 24. Further lets assume that the unsaturated “mouth” end FIG. 25 weighs 1 gram and extends 5 cm from the axis point. Lets assume that the tail weighs 10 grams and extends 4 cm from the axis point. Lets, even further assume that the counterweight weighs 15 grams. When the absorptive is unsaturated the weight of the mouth and counterweight (FIGS. 25 & 6) together (16 grams) outweighs its tail FIG. 24 (10 grams), therefore, the device would naturally fall toward the mouth. Assume that the water level is 4.5 cm underneath the axis. When the device is unsaturated the counterweight causes the mouth downward and it makes contact with the liquid. The liquid then absorbs into the absorptive sponge up and against gravity from the “mouth” FIG. 25, to the “tail” FIG. 24. When the absorbent is saturated, its total weight is 110 grams (11×10). The weight at the mouth end is now 25 grams (1×10+15). The weight of the tail end is now 100 grams (10×10). Since the tail (100 grams) weighs more than the mouth (25 grams), the device falls naturally toward the tail. Note, that since the tail FIG. 24, extends only 4 cm from the axis, when the device turns, there is no contact with the liquid FIG. 9, 17, 22 which is situated 4.5 cm's under the axis. However the mouth, which extends 5 cm's from the axis point, does make contact with the liquid when the absorbent is unsaturated.

Note: these are not theoretical examples, there are working embodiments of this device in existence.

What is claimed is:

1) any method of converting the potential energy of an unsaturated absorbent or unsaturated capillary device into kinetic energy by exposing the device to a liquid, causing the device to move without any outside energy source.

2) any method of converting the potential energy of an unsaturated absorbent or unsaturated capillary device into kinetic energy without an outside energy source, as shown in the images of this patent, whereby the liquid flows (by capillary action) against gravity, past an axle point, causing the device to move: In this movement, simultaneously separating the device from the liquid, and allowing the liquid to substantially disappear by way of evaporation or extraction, and allowing the counterweight to cause the device to return to its starting position, repeating the process without any outside energy source.
